(19) United States
(12) Patent Application Publication
(10) Pub. No.: US 2026/0151978 A1
(43) Pub. Date: Jun. 4, 2026

(54) DETERMINATION DEVICE, DETERMINATION METHOD, AND PRESS MACHINE

(71) Applicant: Panasonic Intellectual Property Management Co., Ltd., Osaka (JP)

(72) Inventor: HIDEAKI HAMADA, Hyogo (JP)

(21) Appl. No.: 19/393,653

(22) Filed: Nov. 19, 2025

(30) Foreign Application Priority Data
Dec. 3, 2024 (JP) 2024-210553

(51) Int. Cl. B30B 15/14; B30B 15/02

(52) U.S. Cl. CPC B30B 15/14; B30B 15/02

(57) ABSTRACT

A determination device according to the present disclosure determines, for a pressing die including a punch, a stripper having a hollow being where the punch is inserted, and a die, whether a size of a clearance between a side surface of the punch and an inner wall of the hollow of the stripper is appropriate. The determination device includes: a load sensor configured to detect a load exerted on the punch; and a controller configured to determine whether the clearance is appropriate based on a detection value of the load sensor. The controller determines that the clearance is not appropriate when the detection value of the load sensor exceeds a predetermined threshold value.

### BACKGROUND

### 1. Technical Field

The present disclosure relates to a determination device, a determination method, and a press machine.

### 2. Description of the Related Art

PTL 1, for example, discloses a pressing die manufactured by mounting at least two die parts, among a plurality of die parts that are in a fitting relationship with a punch, on a mounting base of a blanking machine, in a manner stacked on top of each other, and by blanking a hole on the die parts simultaneously.

### CITATION LIST

### Patent Literature

PTL 1: Unexamined Japanese Patent Publication No. H5-115929

### SUMMARY

A determination device according to one aspect of the present disclosure is a determination device that determines, for a pressing die including a punch, a stripper having a hollow being where the punch is inserted, and a die, whether a size of a clearance between a side surface of the punch and an inner wall of the hollow of the stripper is appropriate, the determination device including:
a load sensor configured to detect a load exerted on the punch; and
a controller configured to determine whether the clearance is appropriate based on a detection value of the load sensor, in which
the controller determines that the clearance is not appropriate when the detection value of the load sensor exceeds a predetermined threshold value.

A determination method according to one aspect of the present disclosure is a determination method for determining, for a pressing die including a punch, a stripper having a hollow being where the punch is inserted, and a die, whether a size of a clearance between a side surface of the punch and an inner wall of the hollow of the stripper is appropriate, the determination method including:
detecting a load exerted on the punch; and
determining whether the clearance is appropriate based on a detected load, in which
the determining includes determining that the clearance is not appropriate when the load detected at the detecting exceeds a predetermined threshold value.

A press machine according to one aspect of the present disclosure includes:
a stripper having a hollow being where the punch is inserted;
a die; and
the determination device described above.

### BRIEF DESCRIPTION OF THE DRAWINGS

FIG. 1 is a block diagram schematically illustrating a determination device according to a first exemplary embodiment;

FIG. 2 is a schematic diagram for explaining determination as to whether a clearance in a pressing die is appropriate, using the determination device illustrated in FIG. 1;

FIG. 3 is a schematic diagram for explaining determination as to whether a clearance in a pressing die is appropriate, using the determination device illustrated in FIG. 1;

FIG. 4 is a schematic diagram for explaining determination as to whether a clearance in a pressing die is appropriate, using the determination device illustrated in FIG. 1;

FIG. 5A is a diagram schematically illustrating motions of a punch, a stripper, and a die in the pressing die illustrated in FIG. 2;

FIG. 5B is a diagram schematically illustrating motions of the punch, the stripper, and the die in the pressing die illustrated in FIG. 2;

FIG. 5C is a diagram schematically illustrating motions of the punch, the stripper, and the die in the pressing die illustrated in FIG. 2;

FIG. 5D is a diagram schematically illustrating motions of the punch, the stripper, and the die in the pressing die illustrated in FIG. 2;

FIG. 5E is a diagram schematically illustrating motions of the punch, the stripper, and the die in the pressing die illustrated in FIG. 2;

FIG. 5F is a diagram schematically illustrating motions of the punch, the stripper, and the die in the pressing die illustrated in FIG. 2;

FIG. 5G is a diagram schematically illustrating motions of the punch, the stripper, and the die in the pressing die illustrated in FIG. 2;

FIG. 6 is a schematic diagram for explaining the clearance between the punch and the stripper;

FIG. 7 is a flowchart for explaining a process of determining the appropriateness of the clearance, the process being performed by the determination device;

FIG. 8 is a graph illustrating a relationship between a load exerted on the punch and the time when the clearance between the punch and the stripper is appropriate;

FIG. 9 is a graph illustrating a relationship between the load exerted on the punch and the time when the clearance between the punch and the stripper is not appropriate;

FIG. 10 is a diagram schematically illustrating a load sensor included in a determination device according to a first modification of the first exemplary embodiment;

FIG. 11 is a schematic diagram illustrating a press machine according to a second exemplary embodiment;

FIG. 12 is a graph illustrating a relationship between a load exerted on a punch and the time, acquired by the press machine in FIG. 11; and

FIG. 13 is a graph illustrating a relationship between a load exerted on a punch and the time, acquired by the press machine in FIG. 11.

### DETAILED DESCRIPTIONS

The punching die described in PTL 1 still has some room for improvement in determining as to whether the clearance between the punch and the die part in the fitting relationship is appropriate.

The present disclosure provides a determination device, a determination method, and a press machine capable of determining whether the size of the clearance between a side surface of the punch and an inner wall of the hollow of the stripper is appropriate.

### Background of the Present Disclosure

In press working in which a plate-like workpiece is punched, generally, a desired shape can be achieved by placing a workpiece on a die, holding the workpiece using a stripper, a stripper plate, or the like, and by punching a part of the workpiece to a predetermined shape, using a punch. Press working by punching has found usage across a wide variety of fields such as home appliances, precision machines, and automobile parts.

When a small part or the like is to be processed, the size of a hole to be punched may be small, or the workpiece may be thin. In such a case, the size of the tip of the punch also becomes smaller, in accordance with the size of the hole to be punched or the thickness of the workpiece. When the tip of the punch becomes smaller, the strength of the punch may become reduced. Therefore, in order to suppress the chances of punch breakage, it has been considered to guide the tip of the punch using a hollow of the stripper or the stripper plate, the hollow being for inserting the punch.

To guide the tip of the punch with the hollow of the stripper or the stripper plate, it is necessary to keep the clearance between the inner wall of the hollow of the stripper or the stripper plate and the side surface of the punch to an appropriate size. If the clearance is not appropriate, sliding resistance generated when the punch is moved increases, and may result in the seizure of the punch.

The present inventors have carried out studies on a determination device, a determination method, and a press machine including the determination device capable of determining whether the clearance is appropriate, and arrived at the following disclosure.

Exemplary embodiments of the present disclosure will be described below with reference to the accompanying drawings. In each of the drawings, elements are exaggerated in order to facilitate the description.

The terms “first”, “second”, and the like herein are only used for description, and should not be understood, either explicitly or implicitly, as indicative of relative importance or a rank of technical features. Limitations such as “first” and “second” given to some features are explicit statements or implications that one or more of such features are included.

### First Exemplary Embodiment

### Overall Configuration

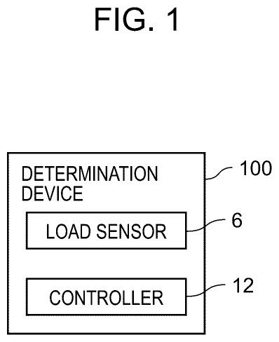

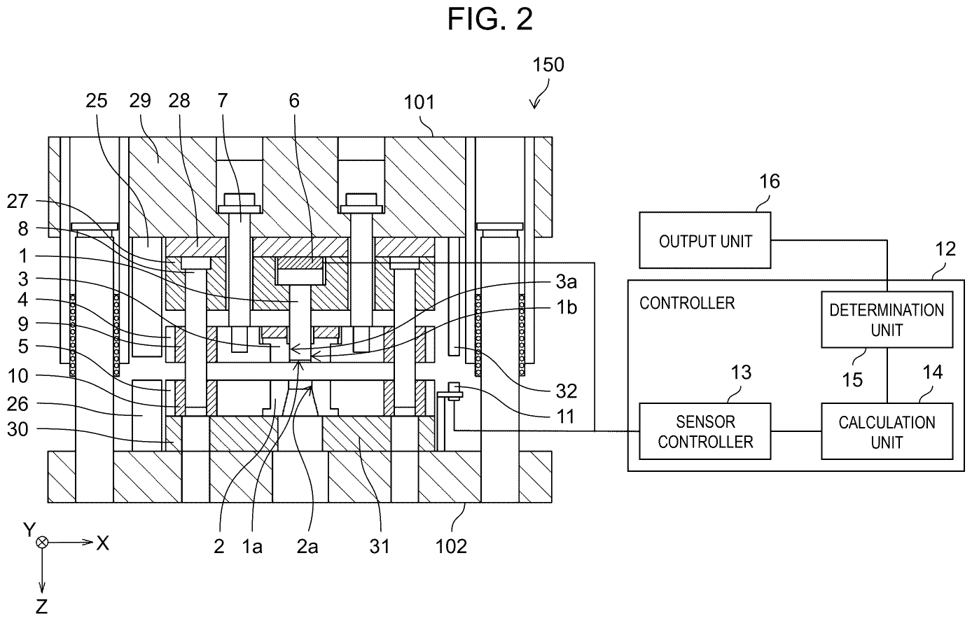

FIG. 1 is a block diagram schematically illustrating determination device 100 according to a first exemplary embodiment. FIGS. 2 to 4 are schematic diagrams for explaining determination as to whether a clearance in pressing die 150 is appropriate, using the determination device illustrated in FIG. 1. The X-Y-Z coordinate system illustrated in the drawings is provided to facilitate the understanding of the exemplary embodiment, and is not intended to limit the scope of the exemplary embodiment in any way. In each of the drawings, the X direction indicates the width direction of pressing die 150, the Y direction indicates the depth direction of pressing die 150, and the Z direction indicates the height direction of pressing die 150.

### Determination Device

Determination device 100 is a device for determining whether the clearance between side surface 1b of punch 1 and the inner wall of hollow 3a of stripper 3 included in pressing die 150, to be described later in detail, is appropriate.

As illustrated in FIG. 1, determination device 100 includes load sensor 6 and controller 12.

Load sensor 6 is a sensor that detects the load exerted on punch 1. In this exemplary embodiment, as illustrated in FIGS. 2 to 4, load sensor 6 is disposed on a surface of punch 1, on the opposite side of press surface 1a. In this exemplary embodiment, one load sensor 6 is disposed on punch 1. As load sensor 6, for example, a piezoelectric force sensor, an electric force sensor such as a strain gauge sensor, or the like may be used.

Controller 12 determines whether the clearance is appropriate on the basis of the detection value of load sensor 6. Controller 12 includes a digital circuit such as a microcomputer, a CPU, an MPU, a GPU, a DSP, an FPGA, or an ASIC, for example. In this exemplary embodiment, as illustrated in FIGS. 2 to 4, controller 12 includes, for example, sensor controller 13 that controls load sensor 6, calculation unit 14, and determination unit 15.

Sensor controller 13 is electrically connected to load sensor 6, and outputs a detection value of load sensor 6 to calculation unit 14. Calculation unit 14 calculates the relationship between the load exerted on punch 1 and the time, on the basis of the load detected by load sensor 6. The relationship between the load exerted on punch 1 and the time will be described later in detail. Determination unit 15 determines whether the clearance between punch 1 and stripper 3 is appropriate.

### Pressing Die

Pressing die 150, which is to be a target of determination of determination device 100, will now be described with reference to FIGS. 2 to 4.

As illustrated in FIGS. 2 to 4, pressing die 150 includes punch 1, stripper 3 having hollow 3a into which punch 1 is inserted, and die 2. In this exemplary embodiment, upper die part 101 including punch 1 and lower die part 102 including die 2 together form pressing die 150. Pressing die 150 is mounted on a press machine (not illustrated) or the like, and is used for punching a workpiece (not illustrated) placed on die 2.

Punch 1 and load sensor 6 are disposed in upper die part 101. Punch plate 27 by which punch 1 and load sensor 6 are fixed, backing plate 28, and upper die set 29 are also disposed in upper die part 101.

Stripper 3, stripper plate 4, stripper guide pin 8, stripper guide bush 9, stripper bolt 7, and upper stopper 25 are further disposed in upper die part 101. Stripper plate 4 is a part that holds stripper 3. Stripper guide pin 8 is a part for positioning stripper plate 4. Stripper guide bush 9 is a part for positioning stripper guide pin 8. Stripper bolt 7 is a part that holds stripper plate 4 while allowing stripper 3 to move. Upper stopper 25 is a part that restricts the movement of punch 1 in the pressing direction (+Z direction). Upper stopper 25 does not necessarily restrict the movement of punch 1 at the time at which a determination as to whether the clearance between punch 1 and stripper 3 is to be made, with the pressing die 150 mounted on the press machine.

Punch 1 is a tool for punching workpiece by being caused to move in the pressing direction (Z direction). As illustrated in FIGS. 2 to 4, punch 1 has press surface 1a facing a workpiece, and side surface 1b connected to press surface 1a.

In this exemplary embodiment, punch 1 has a circular columnar shape having a diameter of 4.5 mm on press surface 1a.

Punch 1 is made of, for example, a cemented carbide material. Examples of the cemented carbide material include an artificial metal (alloy) in which at least one of nine carbides of tungsten (W), chromium (Cr), molybdenum (Mo), titanium (Ti), zirconium (Zr), hafnium (Hf), vanadium (V), niobium (Nb), and tantalum (Ta) is bonded with an Fe-group metal (e.g., Fe, Co, or Ni). As the cemented carbide material for punch 1, for example, an alloy corresponding to VF-20 of the Cemented Carbide Tool Standards Association (CIS) may be used.

Stripper 3 is a tool for holding the workpiece placed on die 2 while the workpiece is to be punched with punch 1. Stripper 3 has hollow 3a into which punch 1 is inserted. hollow 3a has a shape of a through hole into which punch 1 can be inserted. In this exemplary embodiment, hollow 3 a has a circular cross section having a diameter of 4.502 mm, and is a through hole penetrating stripper 3 in the Z direction.

Stripper 3 is made of, for example, a cemented carbide material, in the same manner as punch 1. As the cemented carbide material for stripper 3, an alloy corresponding to VM-30 of the Cemented Carbide Tool Standards Association (CIS) may be used.

Die 2, stripper guide bush 10, and lower stopper 26 are disposed in lower die part 102. Die plate 5 for fixing die 2, die backing plate 30 for distributing the impact at the time of punching, and lower die set 31 are also disposed in lower die part 102. Stripper guide bush 10 is a part for positioning stripper guide pin 8. Lower stopper 26 is a part that restricts the movement of punch 1.

In this exemplary embodiment, position sensor 11 is disposed in lower die part 102. Position sensor 11 detects the distance of punch 1 with respect to the bottom dead center, by detecting the position of block 32 disposed on upper die part 101. The bottom dead center is the lowest position that punch 1 can take. Position sensor 11 includes, for example, a displacement sensor or the like capable of measuring an extremely small distance interval with respect to a measurement target, in a non-contact manner.

Die 2 is a tool on which a workpiece is placed while pressing. Die 2 has hollow 2a into which punch 1 is inserted. Hollow 2a has a shape of a through hole into which punch 1 can be inserted. In this exemplary embodiment, hollow 2a has a circular cross section having a diameter of 4.506 mm, and is a through hole penetrating die 2 in the Z direction.

Die 2 is made of, for example, a cemented carbide material, in the same manner as punch 1 and stripper 3. As the cemented carbide material for die 2, an alloy corresponding to VF-40 of the Cemented Carbide Tool Standards Association (CIS) may be used.

In this exemplary embodiment, as illustrated in FIGS. 2 to 4, output unit 16 is connected to controller 12 of determination device 100. Output unit 16 includes, for example, a display, such as a liquid crystal display, presenting visual information, or a speaker presenting auditory information such as sound or a buzzer.

### Determination of Appropriateness of Clearance

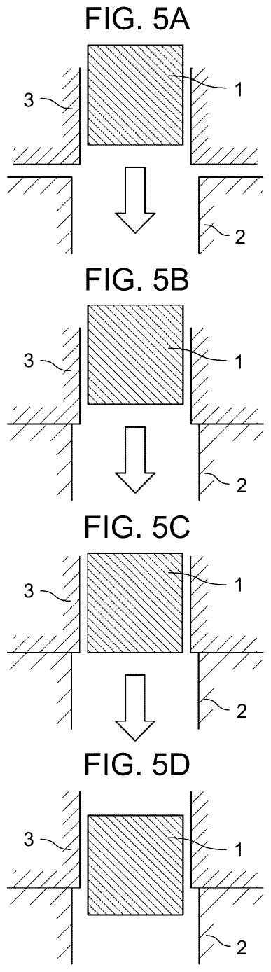

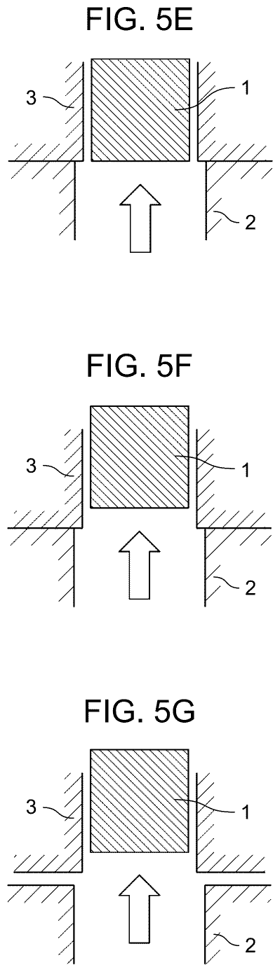

The determination made by determination device 100, as to whether the clearance is appropriate, will now be described with reference to FIGS. 2 to 4 and FIGS. 5A to 5G. FIGS. 5A to 5G are diagrams schematically illustrating motions of punch 1, stripper 3, and die 2 in pressing die 150 illustrated in FIG. 2.

In this exemplary embodiment, controller 12 determines whether the clearance is appropriate on the basis of a detection value of load sensor 6 when punch 1 is caused to move without pressing die 150 mounted on the press machine. The appropriateness of the clearance is determined on the basis of the detection value of the load sensor when upper die part 101 of pressing die 150, illustrated in FIGS. 2 to 4, is moved down from the position above lower die part 102 toward lower die part 102 until punch 1 reaches the bottom dead center, and upper die part 101 is then moved up again. This up and down motion of upper die part 101 is achieved by causing a crane or the like to move upper die part 101 up and down, using a hanging bolt mounted on upper die set 29, for example.

FIG. 2 illustrates a state of upper die part 101 not having moved from the initial position. That is, in FIG. 2, punch 1 is located at the top dead center which is the highest position that punch 1 can take. In the state illustrated in FIG. 2, because no load is being exerted on punch 1, the detection value of load sensor 6 is zero. At this time, punch 1, die 2, and stripper 3 are in a positional relationship as illustrated in FIG. 5A.

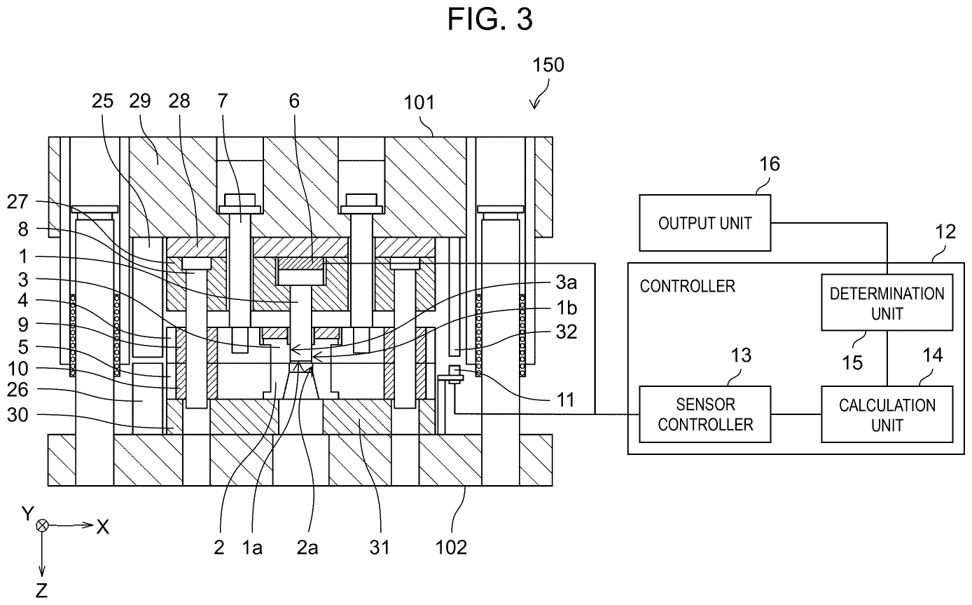

FIG. 3 illustrates a state after upper die part 101 has started moving down, and stripper plate 4 and die plate 5 have come into contact with each other. At this time, punch 1, die 2, and stripper 3 are in a positional relationship illustrated in FIG. 5B. As upper die part 101 is moved down further after stripper plate 4 and die plate 5 have come into contact with each other, punch 1 is caused to move down further, while stripper 3 remains stationary. As upper die part 101 moves down further from the state illustrated in FIGS. 3 and 5B, punch 1 becomes displaced from the position illustrated in FIG. 5B to the position illustrated in FIG. 5C. Between FIG. 5B and FIG. 5C, only the position of punch 1 changes, while the positions of die 2 and stripper 3 remain the same. In other words, when upper die part 101 moves further down from the state illustrated in FIG. 3, punch 1 starts moving relatively with respect to stripper 3. As punch 1 moves relatively with respect to stripper 3, sliding resistance is generated between the inner wall of hollow 3a of stripper 3 and side surface 1b of punch 1. The sliding resistance corresponds to the load exerted on punch 1. In other words, when upper die part 101 starts to move down and reaches the state illustrated in FIG. 3, a load starts to be exerted on punch 1.

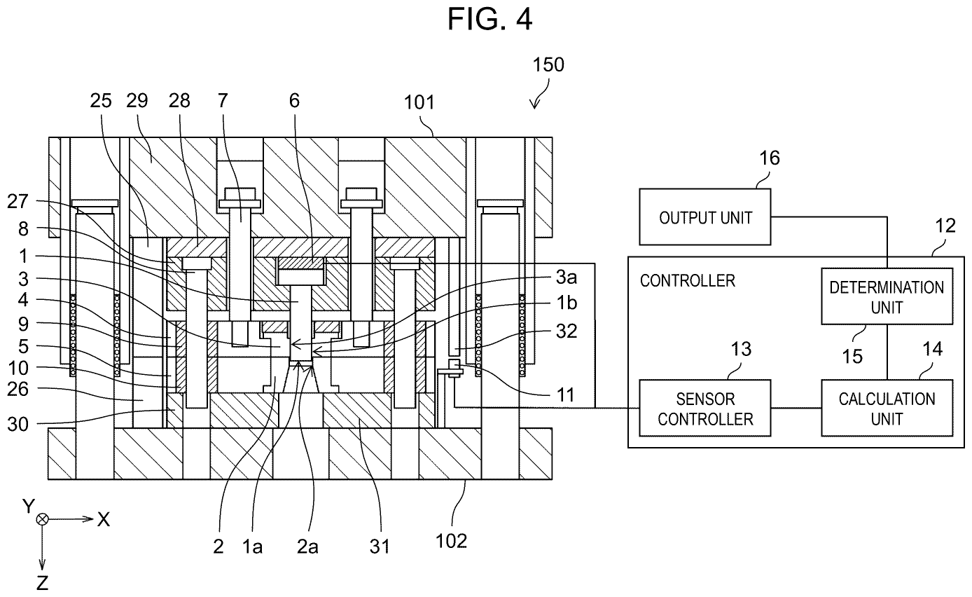

FIG. 4 illustrates a state in which upper die part 101 moves further down, and punch 1 arrives at the bottom dead center. At this time, punch 1, die 2, and stripper 3 are in the positional relationship illustrated in FIG. 5D. While punch 1 remains stationary at the bottom dead center, the sliding resistance is kept being exerted between side surface 1b of punch 1 and the inner wall of hollow 3a of stripper 3, and the detection value of load sensor 6 remains at substantially the same value as that prior to the point at which punch 1 reaches the bottom dead center.

From the state illustrated in FIG. 4, upper die part 101 is caused to move in a direction away from lower die part 102, and pressing die 150 passes through the state illustrated in FIG. 3, and goes back to the state illustrated in FIG. 2. The positional relationship among punch 1, die 2, and stripper 3 changes from the state illustrated in FIG. 5D where punch 1 is at the bottom dead center, changes to those illustrated in FIGS. 5E and 5F, one after another, and goes back to the state illustrated in FIG. 5G. In FIGS. 5A and 5G, punch 1, die 2, and stripper 3 are in the same positional relationship.

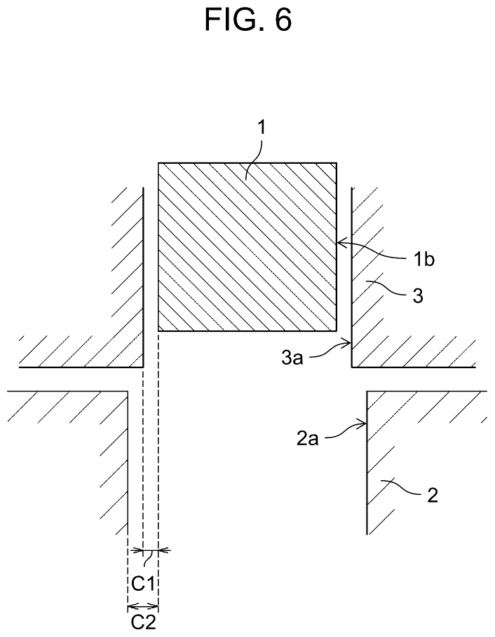

The clearance between side surface 1b of punch 1 and the inner wall of hollow 3a of stripper 3 will now be described with reference to FIG. 6. FIG. 6 is a schematic diagram for explaining the clearance between punch 1 and stripper 3.

As described earlier, press surface 1a of punch 1 has a circular shape with a diameter of 4.5 mm. hollow 3 a of stripper 3 is a through hole having a circular cross section allowing punch 1 to be inserted. Hollow 3a of stripper 3 has a cross section with a diameter of 4.502 mm. Therefore, clearance c1 between the inner wall of hollow 3 a of stripper 3 and side surface 1b of punch 1 is c1=0.001 mm, as illustrated in FIG. 6. hollow 2a of die 2 also is a through hole having a circular cross section allowing punch 1 to be inserted. hollow 2a of die 2 has a cross section with a diameter of 4.506 mm. Therefore, the clearance c2 between hollow 2a of die 2 and punch 1 is c2=0.003 mm. Note that the shapes and sizes of punch 1, hollow 3a of stripper 3, and hollow 2a of die 2 are merely examples, and are not limited to those described above.

Generally, the positional relationship between punch 1 and die 2 is adjusted so that the clearance between die 2 and punch 1 is about 1/10 of the thickness of the workpiece. In order to allow punch 1 to be guided along hollow 3a of stripper 3, the clearance between stripper 3 and punch 1 is preferably smaller than the clearance between die 2 and punch 1. Therefore, the positional relationship between punch 1 and stripper 3 is adjusted so that clearance c1 between stripper 3 and punch 1 takes a value more than or equal to one-third and less than or equal to a half of clearance c2 between die 2 and punch 1. In this exemplary embodiment, the appropriate value of clearance c1 between punch 1 and stripper 3 may be, for example, a value within a range from 0.001 mm to 0.0015 mm, inclusive.

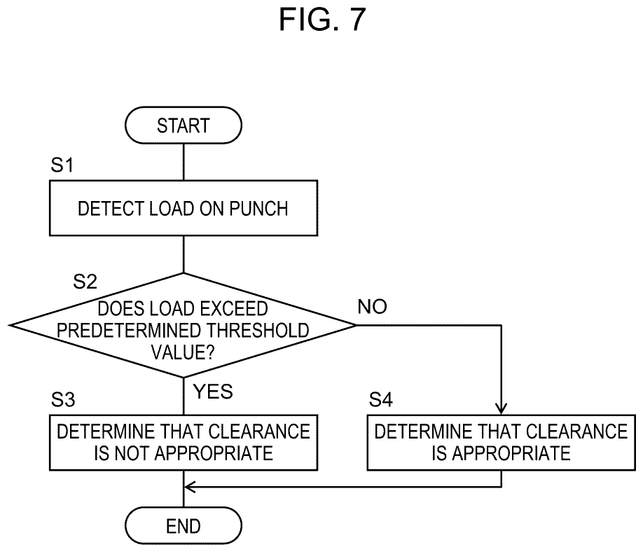

FIG. 7 is a flowchart for explaining a process of determining the appropriateness of the clearance, the process being performed by determination device 100. This clearance determination process will now be described with reference to FIG. 7.

In step S1, load sensor 6 keeps detecting the load exerted on punch 1 during the time from when upper die part 101 starts moving down toward lower die part 102 to when upper die part 101 having moved up again goes back to the original position.

Next, in step S2, controller 12 determines whether any value of the load exerted on punch 1, as detected by load sensor 6, exceeds a predetermined threshold value.

If the value of the load exerted on punch 1 exceeds the predetermined threshold value, that is, if YES in step S2, controller 12 determines that the clearance is not appropriate in step S3.

If the load exerted on punch 1 is less than or equal to the predetermined threshold value, that is, if NO in step S2, controller 12 determines that the clearance is appropriate in step S4.

The process in each step S1 to S4 will now be described in detail.

In step S1, load sensor 6 detects the load exerted on punch 1 during the time from when punch 1 starts moving from the top dead center toward the bottom dead center to when punch 1 having reached the bottom dead center goes back to the top dead center again. For example, by detecting the position of punch 1 by position sensor 11, the motion of punch 1 can be detected. At this time, sensor controller 13 in controller 12 outputs the detection value of load sensor 6 to calculation unit 14 in controller 12.

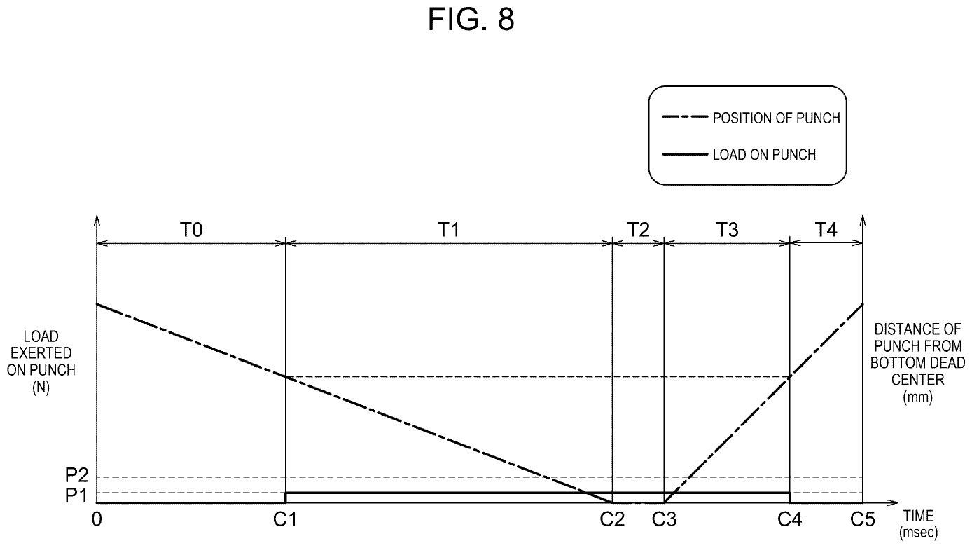

In step S2, calculation unit 14 in controller 12 calculates the relationship between the detection value of load sensor 6 and the time. The relationship between the detection value of load sensor 6 and the time can be expressed as, for example, the graph illustrated in FIG. 8. FIG. 8 is a graph illustrating a relationship between a load exerted on punch 1 and the time when the clearance between punch 1 and stripper 3 is appropriate.

In the graph in FIG. 8, the left vertical axis represents the load (unit: N) exerted on the punch; the right vertical axis represents the distance (unit: mm) of punch 1 with respect to the bottom dead center; and the horizontal axis represents time (unit: msec). The graph in the one-dot chain line indicates the distance of punch 1 with respect to the bottom dead center, that is, the position of the punch, and the graph in the solid line indicates the load exerted on punch 1. The graph illustrated in FIG. 8 indicates that punch 1 is at the top dead center at time 0; as the time elapses, punch 1 moves down and reaches the bottom dead center at time C2; and punch 1 starts moving up again at time C3. The distance of punch 1 with respect to the bottom dead center can be detected using position sensor 11, for example.

As upper die part 101 is caused to move down, punch 1 also moves down from the top dead center, together with stripper 3. At time C1, stripper plate 4 and die plate 5 come into contact with each other. In the example illustrated in FIG. 8, time T0 has elapsed, that is, it has taken until time C1 from when punch 1 has started moving down toward the bottom dead center to when stripper plate 4 and die plate 5 have come into abutment against each other.

As upper die part 101 is caused to move down further, because stripper plate 4 and die plate 5 have come into contact with each other, the stripper 3 stops moving down, but punch 1 keeps moving down further. At this time, with punch 1 moving relatively with respect to stripper 3, sliding resistance is generated between the inner wall of hollow 3a of stripper 3 and side surface 1b of punch 1. The load resultant of the sliding resistance between stripper 3 and punch 1 is exerted on punch 1, and the load is detected by load sensor 6. FIG. 8 illustrates that a load having a magnitude P1 is detected by load sensor 6. The sliding resistance experienced by punch 1, as punch 1 moves down while stripper 3 remains stationary, is substantially constant.

When upper die part 101 moves down further, upper stopper 25 and lower stopper 26 come into abutment against each other at time C2, and upper die part 101 stops moving down. Time T1 has elapsed from time C1 to when punch 1 stops moving down. Between time C1 and time C2, as illustrated in FIG. 8, a load having a magnitude of P1 is being exerted on punch 1.

Between time C2 and time C3, because the sliding resistance is exerted although punch 1 remains stationary at the bottom dead center, a load of the magnitude of P1 is being exerted on punch 1. The time for which punch 1 remains stationary at the bottom dead center is time T2.

As upper die part 101 then moves up at time C3, upper stopper 25 and lower stopper 26 separate from each other, and punch 1 moves up, with stripper plate 4 and die plate 5 in contact with each other. Because stripper plate 4 and die plate 5 are still in contact with each other, sliding resistance is generated again between stripper 3 and punch 1.

As upper die part 101 continues to move up, stripper plate 4 also starts moving up with upper die part 101, and stripper plate 4 and die plate 5 separate from each other at time C4. The time from time C3 to time C4 is time T3. Between time C3 and time C4, a load having the same magnitude P1 as that from time C1 to time C2 is being exerted on punch 1.

After stripper plate 4 and die plate 5 separate from each other at time C4, because both stripper 3 and punch 1 move up, the sliding resistance becomes zero again, and the load exerted on punch 1 also becomes zero. The time from time C4 to time C5 at which punch 1 goes back to the top dead center is time T4.

By causing upper die part 101 to move up and down at a predetermined speed, time C1 to time C5 arrive substantially at the same timing within every cycle. In other words, it can be said that the lengths of time T0 to time T4 in every cycle remain substantially the same. Therefore, it is also possible to estimate the timing of time C1 to time C5 from when punch 1 has started moving down, instead of using position sensor 11. Note that the timing of time C1 to time C5 may vary depending on the speed at which upper die part 101 is moved up or down.

As illustrated in FIG. 8, a load is exerted on punch 1 between time C1 and time C4. In step S3, determination unit 15 determines whether the clearance is appropriate on the basis of the detection value of the load sensor during the period from time 0 at which punch 1 has started moving from the top dead center toward the bottom dead center, to time C5 at which punch 1 goes back to the top dead center again, after reaching the bottom dead center. In other words, determination unit 15 can determine that the clearance is appropriate when the maximum value of the load exerted on punch 1 from time 0 to time C5 is less than or equal to predetermined threshold value P2.

As the clearance between punch 1 and stripper 3 decreases, the sliding resistance between punch 1 and stripper 3 also increases. Therefore, when the load exerted on punch 1 exceeds predetermined threshold value P2, determination unit 15 can determine that the clearance is too small and thus is not appropriate. In this exemplary embodiment, determination unit 15 makes such a determination when the clearance is smaller than the appropriate value, but does not make a determination when the clearance is greater than the appropriate value.

In the example illustrated in FIG. 8, between time C1 and time C4, a load having a magnitude of P1 is being exerted on punch 1. Because the load having a magnitude of P1 does not exceed predetermined threshold value P2, determination unit 15 can determine that the clearance between punch 1 and stripper 3 is appropriate.

Predetermined threshold value P2 may be, for example, 1.0 N. Predetermined threshold value P2 can be determined on the basis of the material or the thickness of the workpiece, the clearance, the structure of the die, and the like, which are determined by the shape to be achieved by punching of punch 1.

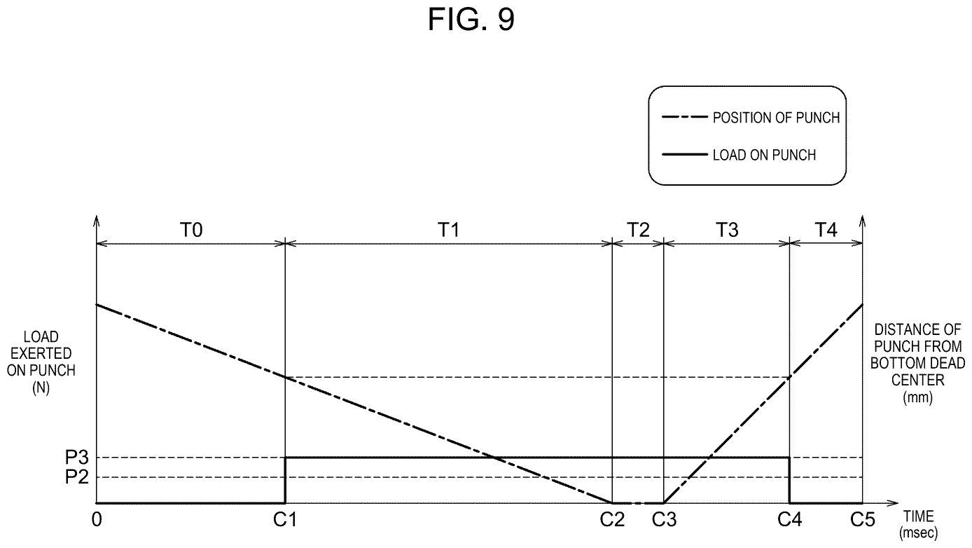

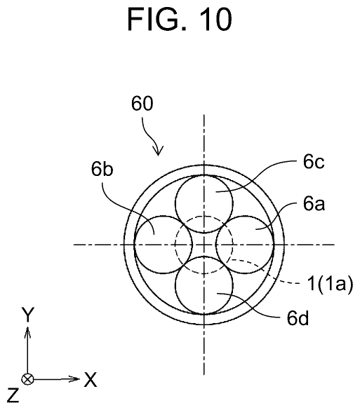

FIG. 9 is a graph illustrating a relationship between a load exerted on punch 1 and the time when the clearance between punch 1 and stripper 3 is not appropriate. In the graph in FIG. 9, the left vertical axis represents the load (unit: N) exerted on the punch; the right vertical axis represents the distance (unit: mm) of punch 1 with respect to the bottom dead center; and the horizontal axis represents time (unit: msec), in the same manner as in the graph in FIG. 8.

In the example illustrated in FIG. 9, between time C1 and time C4, a load having a magnitude of P3 is being exerted on punch 1. Because the maximum value of the magnitude of the load exerted on punch 1 between time 0 and time C5 exceeds predetermined threshold value P2, determination unit 15 determines that the clearance between punch 1 and stripper 3 is not appropriate.

After determination unit 15 determines the appropriateness of the clearance, controller 12 may output a determination result to output unit 16. By adjusting the assembly of pressing die 150 to adjust the clearance on the basis of the determination result, and then determining the clearance again, an appropriate clearance between punch 1 and stripper 3 can be ensured.

In this exemplary embodiment, it is possible to determine the appropriateness of the clearance between punch 1 and stripper 3, without having pressing die 150 mounted on the press machine. By determining the appropriateness of the clearance during an adjustment stage of the die before mounting the die on the press machine, the clearance between punch 1 and stripper 3 can be set more precisely.

### Effects

With the exemplary embodiment described above, it is possible to achieve the following effects.

Determination device 100 is a device that determines, for pressing die 150 including punch 1, stripper 3, and die 2, whether the size of the clearance between side surface 1b of punch 1 and the inner wall of hollow 3a of stripper 3 is appropriate. Determination device 100 includes load sensor 6 and controller 12. Load sensor 6 detects the load exerted on punch 1. Controller 12 determines whether the size of the clearance is appropriate on the basis of the detection value of load sensor 6. Controller 12 determines that the clearance is not appropriate when the detection value of load sensor 6 exceeds predetermined threshold value P2.

With such a configuration, it is possible to provide a determination device capable of determining whether the size of the clearance between the side surface of the punch and the inner wall of the hollow of the stripper is appropriate.

Controller 12 determines whether the clearance is appropriate on the basis of the detection value of load sensor 6. The detection value is detected during the time from when punch 1 has started moving from the top dead center toward the bottom dead center to when punch 1 having reached the bottom dead center arrives at the top dead center again.

With such a configuration, the appropriateness of the clearance can be determined more precisely.

Controller 12 determines whether the clearance is appropriate on the basis of the detection value of load sensor 6. The detection value is detected when punch 1 is caused to move without pressing die 150 mounted on the press machine.

With such a configuration, maintainability of pressing die 150 can be improved.

A determination method for determining, for a pressing die including punch 1, stripper 3, and die 2, whether a size of a clearance between side surface 1b of punch 1 and an inner wall of hollow 3a of stripper 3 is appropriate, the determination method includes detecting a load exerted on the punch, and determining whether the clearance is appropriate, on the basis of a detected load. The determining includes determining that the clearance is not appropriate when the detected load exceeds a predetermined threshold.

With such a configuration, it is possible to provide a determination method capable of determining whether the size of the clearance between the side surface of the punch and the inner wall of the hollow of the stripper is appropriate.

In the exemplary embodiment described above, an example in which punch 1 has circular press surface 1a has been described, but the present disclosure is not limited thereto. Press surface 1a of punch 1 may have any shape. In addition, hollow 3a of stripper 3 and hollow 2a of die 2 may be set to any shape in accordance with the shape of punch 1.

Furthermore, in the exemplary embodiment described above, an example in which stripper 3 is fixed to stripper plate 4 has been described, but the present disclosure is not limited thereto. Stripper 3 and stripper plate 4 may be formed integrally.

Furthermore, in the exemplary embodiment described above, an example in which die 2 is fixed to die plate 5 has been described, but the present disclosure is not limited thereto. Die 2 and die plate 5 may be formed integrally.

Furthermore, in the exemplary embodiment described above, an example in which a crane is used to move upper die part 101 up and down has been described, but the present disclosure is not limited thereto. For example, upper die part 101 may be mounted on a vertically movable device or the like, instead of a crane, to move upper die part 101 up and down.

In the exemplary embodiment described above, an example in which determination device 100 includes load sensor 6 has been described, but the present disclosure is not limited thereto. Controller 12 included in determination device 100 may acquire information of the load of punch 1 from outside, and determine the appropriateness of the clearance on the basis of the information.

Furthermore, in the exemplary embodiment described above, an example in which the position of punch 1 is detected using position sensor 11 has been described, but the present disclosure is not limited thereto. Controller 12 may estimate the position of punch 1 on the basis of the time from when punch 1 has started moving down.

In the exemplary embodiment described above, an example in which predetermined threshold value P2 is 1.0 N has been described, but the present disclosure is not limited thereto. Predetermined threshold value P2 may be a value calculated through statistical processing, machine learning, or the like.

Furthermore, in the exemplary embodiment described above, an example of determining whether the clearance is appropriate on the basis of the load exerted on punch 1 within one cycle from when punch 1 moves from the top dead center, reaches the bottom dead center, and then goes back to the top dead center again has been described, but the present disclosure is not limited thereto. For example, it is possible to repeat the cycle in which punch 1 moves from the top dead center, reaches the bottom dead center, and goes back to the top dead center a plurality of times, and to determine whether the clearance is appropriate on the basis of the load exerted on punch 1.

In the exemplary embodiment described above, the example in which determination unit 15 of controller 12 determines the appropriateness of the clearance on the basis of the detection value of load sensor 6 during the time from when punch 1 has started moving from the top dead center toward the bottom dead center to when punch 1 having reached the bottom dead center goes back to the top dead center again has been described, but the present disclosure is not limited thereto. As described with reference to FIGS. 8 to 9, a load is exerted on punch 1 between time C1 and time C4, and the load exerted on punch 1 becomes 0 between time 0 and time C1 and between time C4 and time C5. Therefore, determination unit 15 may determine whether the clearance is appropriate on the basis of the detection value of the load sensor over a predetermined period from when punch 1 has started moving from the top dead center toward the bottom dead center. Specifically, determination unit 15 may determine whether the clearance between punch 1 and stripper 3 is appropriate on the basis of the load exerted on punch 1 during the period between time C1 and time C4.

### Modifications

FIG. 10 is a diagram schematically illustrating load sensor 60 included in a determination device according to a first modification of the first exemplary embodiment. As illustrated in FIG. 10, load sensor 60 may include four load sensors 6a to 6d. In this case, four load sensors 6a to 6d may be disposed at equal intervals on the surface of punch 1 on the opposite side of press surface 1a. In the example illustrated in FIG. 10, four load sensors 6 a to 6 d are disposed at intervals of 90 degrees along the outer circumference of press surface 1a of punch 1. Furthermore, determination unit 15 of controller 12 may identify the position of a part where the clearance is not appropriate in side surface 1b of punch 1, on the basis of the detection values of the respective four load sensors 6a to 6 d. With such a configuration, the clearance between punch 1 and stripper 3 can be adjusted more precisely.

### Second Exemplary Embodiment

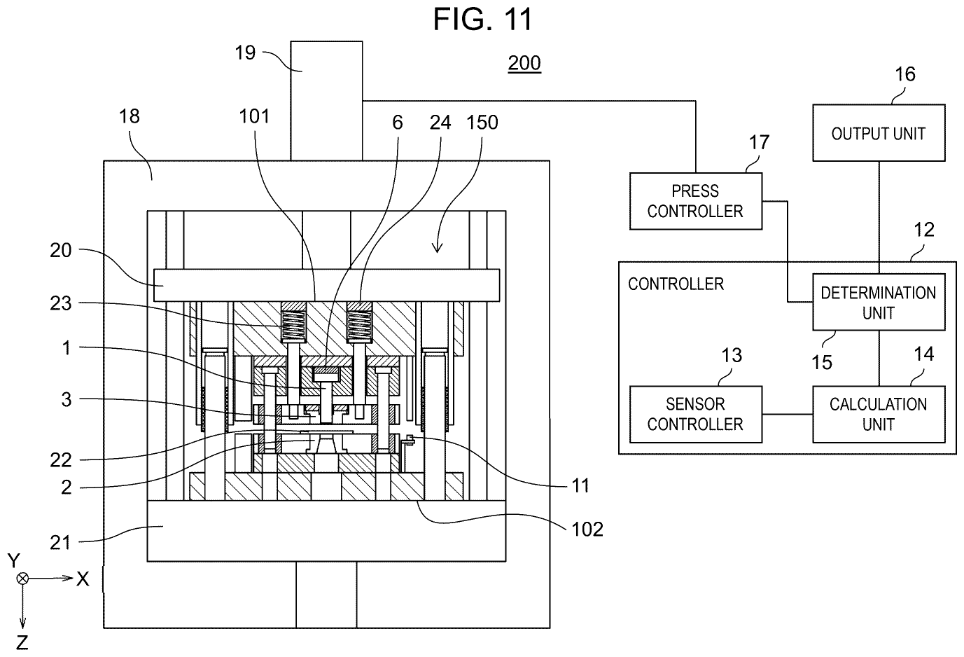

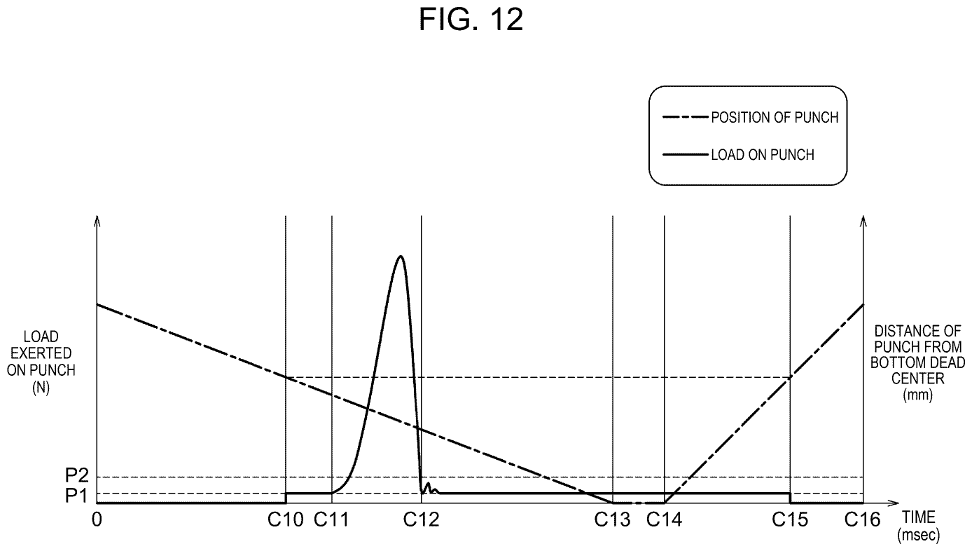

A second exemplary embodiment will now be described with reference to FIGS. 11 to 13. The second exemplary embodiment includes configurations identical or equivalent to those in the first exemplary embodiment, with such configurations being denoted by the same reference signs as those in the first exemplary embodiment. The description redundant with that in the first exemplary embodiment will be omitted in the second exemplary embodiment.

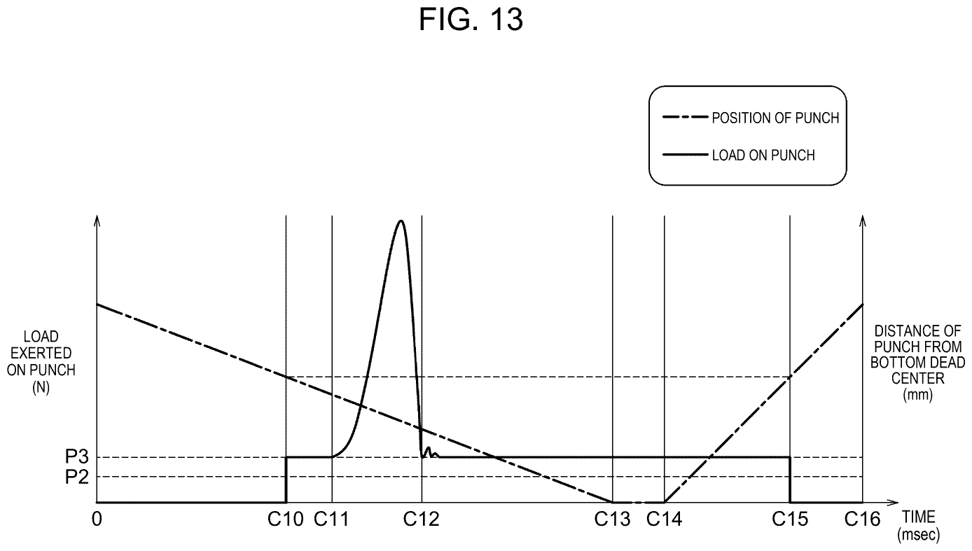

FIG. 11 is a schematic diagram illustrating press machine 200 according to the second exemplary embodiment. FIGS. 12 and 13 are graphs illustrating a relationship between the load exerted on punch 1 and the time, acquired by the press machine 200 in FIG. 11. As illustrated in FIG. 11, the second exemplary embodiment is different from the first exemplary embodiment in that controller 12 determines whether the clearance is appropriate on the basis of the detection value of load sensor 6 by moving punch 1, with pressing die 150 mounted on a press machine and workpiece 22 placed on die 2.

Press machine 200 includes punch 1, stripper 3, die 2, and determination device 100, and is a device for punching workpiece 22. Press machine 200 includes pressing die 150 and determination device 100 described in the first exemplary embodiment. In the second exemplary embodiment, determination device 100 detects a load exerted on punch 1 while workpiece 22 is being punched in press machine 200 having pressing die 150 mounted thereon, and determines whether the clearance between punch 1 and stripper 3 is appropriate on the basis of a detected load.

To begin with, press machine 200 will be described with reference to FIG. 11. Press machine 200 is a device that performs punching on plate-shaped workpiece 22. One example of press machine 200 is a servo screw press machine that can be controlled highly precisely. In press machine 200, pressing die 150 is mounted on press machine body 18. As illustrated in FIG. 11, upper die part 101 of pressing die 150 is mounted on slide 20 of press machine body 18, and lower die part 102 of pressing die 150 is mounted on bolster 21 of press machine body 18. Upper die part 101 is mounted on slide 20 with spring 23 and screw plug 24 therebetween. Because pressing die 150 has the same configuration as pressing die 150 described in the first exemplary embodiment, the description thereof will be omitted.

In press machine 200, workpiece 22 can be punched by causing servomotor 19 to rotate so as to drive slide 20 up and down in the pressing direction (Z direction), on the basis of an instruction from press controller 17. At the time of punching, by causing slide 20 to move down, stripper 3 is caused to press workpiece 22 against die 2. Workpiece 22 is then punched by punch 1 while workpiece 22 is being held by stripper 3.

In press machine 200, a conveying unit (not illustrated) conveys a plurality of workpieces 22 or workpiece 22 in the form of a coil material in the X direction or the Y direction, in synchronization with the pressing operation of press machine body 18, and punching is performed sequentially.

In this exemplary embodiment, workpiece 22 is, for example, formed of SUS301-EH material, which is a type of steel classified as austenitic stainless steel. The SUS301-EH material is, for example, a material used as a mainspring or a spring of an automobile part. Workpiece 22 has, for example, a thickness of 0.03 mm, a hardness of 529 HV, and a tensile strength of 1,679 N/mm².

Press controller 17 drives servomotor 19 so as to drive driving slide 20 up and down in the pressing direction (Z direction) at a predetermined speed. Press controller 17 includes a digital circuit such as a microcomputer, a CPU, an MPU, a GPU, a DSP, an FPGA, or an ASIC, for example. Press controller 17 may be the same hardware as controller 12 of determination device 100.

Determination device 100 determines the appropriateness of the clearance between punch 1 and stripper 3 on the basis of the detection value of load sensor 6 when punch 1 is moved with pressing die 150 mounted on press machine 200 and workpiece 22 placed on die 2.

The load exerted on punch 1 when workpiece 22 is punched will now be described with reference to the graphs of FIGS. 12 to 13. When press controller 17 drives servomotor 19, slide 20 moves down, together with upper die part 101. At time C10, stripper plate 4 (stripper 3) and die plate 5 (die 2) come into abutment against each other. At the time of punching workpiece 22, it is possible for stripper plate 4 (stripper 3) and die plate 5 (die 2) not to come into abutment against each other directly, but come into abutment against each other with workpiece 22 therebetween.

As upper die part 101 is caused to move down further, punch 1 is caused to move down, while stripper 3 remains stationary, between time C10 and time C11. At this time, because sliding resistance is generated between punch 1 and stripper 3, load sensor 6 detects a load of a magnitude of P1 being exerted on punch 1.

At time C11, punch 1 comes into abutment against workpiece 22. When punch 1 comes into abutment against workpiece 22, and upper die part 101 is caused to move down further, and punch 1 is caused to punch workpiece 22. At time C12, workpiece 22 is punched by punch 1 and a hole is formed. Load sensor 6 detects the highest value of the load exerted on punch 1, between time C11 and time C12. The load detected in the process of punching workpiece 22 with punch 1, that is, during the time period from time C11 to time C12 is a load exerted on punch 1 as workpiece 22 is punched, and cannot be used to determine the clearance.

When upper die part 101 moves down further, punch 1 reaches the bottom dead center at time C13, and punch 1 remains stationary between time C13 and time C14 at the bottom dead center. At this time, specifically, between time C12 and time C14, a load may be generated between punch 1 and workpiece 22 due to workpiece 22 having been punched by punch 1, that is, by the scrap falling into the hollow of die 2. In such a case, the load exerted on punch 1 may take a value higher than the magnitude P1.

Upper die part 101 is then caused to move up again at time C14, and stripper plate 4 (stripper 3) and die plate 5 (die 2) having been in abutment against each other, with workpiece 22 therebetween, separate from each other at time C15.

Upper die part 101 is then caused to move up further, so that punch 1 goes back to the top dead center at time C16. The load exerted on punch 1 between time C15 and time C16 is zero.

As described above, load sensor 6 detects a load at the time of punching workpiece 22 and a load due to the friction between punched workpiece 22 and punch 1. Therefore, in order to determine the appropriateness of the clearance between punch 1 and stripper 3 more accurately, controller 12 determines the appropriateness of the clearance on the basis of the load detected by load sensor 6 between time C10 and time C11, which is not affected by workpiece 22. In other words, controller 12 determines whether the clearance is appropriate on the basis of the detection value of load sensor 6 during a time period from when stripper 3 and die 2 come into abutment against each other with workpiece 22 interposed therebetween, to when punch 1 comes into abutment against workpiece 22.

Controller 12 may determine whether the clearance is appropriate on the basis of the detection value of load sensor 6 between time C14 and time C15 during which the effect of workpiece 22 is small. In other words, controller 12 may determine whether the clearance is appropriate on the basis of the detection value of load sensor 6 during a time period from when punch 1 having punched workpiece 22 separates from workpiece 22 to when punch 1 goes back to the top dead center.

FIG. 12 illustrates an example in which the clearance between punch 1 and stripper 3 is appropriate, and FIG. 13 illustrates an example in which the clearance between punch 1 and stripper 3 is not appropriate. For example, in the example illustrated in FIG. 12, the load exerted on punch 1 between time C10 and time C11 exhibits a magnitude P1, and is smaller than predetermined threshold value P2. Therefore, in the case illustrated in FIG. 12, determination unit 15 in controller 12 determines that the clearance is appropriate. By contrast, in the example illustrated in FIG. 13, the load exerted on punch 1 between time C10 and time C11 exhibits a magnitude P3, and exceeds predetermined threshold value P2. Therefore, in the case illustrated in FIG. 13, determination unit 15 in controller 12 determines that the clearance is not appropriate. Controller 12 may output the determination result to output unit 16.

Controller 12 may determine whether the clearance is appropriate while press machine 200 is performing punching. When it is determined that the clearance is not appropriate during punching process, it is possible to stop press controller 17 from driving servomotor 19, to temporarily stop the production, and to adjust pressing die 150.

### Supplementary Notes

The exemplary embodiments described above disclose the following techniques.

### Technique 1

A determination device that determines, for a pressing die including a punch, a stripper having a hollow being where the punch is inserted, and a die, whether a size of a clearance between a side surface of the punch and an inner wall of the hollow of the stripper is appropriate, the determination device comprising: a load sensor configured to detect a load exerted on the punch; and a controller configured to determine whether the clearance is appropriate based on a detection value of the load sensor, wherein the controller determines that the clearance is not appropriate when the detection value of the load sensor exceeds a predetermined threshold value.

With such a configuration, it is possible to provide a determination device capable of determining whether the size of the clearance between the side surface of the punch and the inner wall of the hollow of the stripper is appropriate.

### Technique 2

The determination device according to Technique 1, wherein the controller determines whether the clearance is appropriate based on the detection value of the load sensor, the detection value being detected during the time from when the punch has started moving from a top dead center toward a bottom dead center to when the punch having reached the bottom dead center arrives at the top dead center again.

With such a configuration, it is possible to determine whether the clearance between the punch and the stripper is appropriate, more accurately.

### Technique 3

The determination device according to Technique 1 or 2, wherein the controller determines whether the clearance is appropriate based on the detection value of the load sensor, the detection value being detected when the punch is caused to move, without the pressing die being mounted on the press machine.

With such a configuration, the clearance can be maintained appropriately before the pressing die is mounted on the press machine.

### Technique 4

The determination device according to Technique 3, wherein the controller determines whether the clearance is appropriate based on the detection value of the load sensor, the detection value being detected during a predetermined period of the time from when the punch has started moving from the top dead center toward the bottom dead center to when the punch having reached the bottom dead center arrives at the top dead center again.

With such a configuration, it is possible to determine whether the clearance between the punch and the stripper is appropriate, more accurately.

### Technique 5

The determination device according to Technique 1 or 2, wherein the controller determines whether the clearance is appropriate based on the detection value of the load sensor, the detection value being detected when the punch is caused to move, with the pressing die being mounted on the press machine and a workpiece being placed on the die.

With such a configuration, it is possible to determine whether the clearance between the punch and the stripper is appropriate during the production. For this reason, when it is found that the clearance is not appropriate during the production, a response can be taken at an early stage, so the production efficiency can be improved.

### Technique 6

The determination device according to Technique 5, wherein the controller determines whether the clearance is appropriate based on the detection value of the load sensor, the detection value being detected during a time period from when the stripper and the die come into contact with each other with the workpiece interposed therebetween, to when the punch comes into contact with the workpiece.

With such a configuration, it is possible to determine whether the clearance between the punch and the stripper is appropriate without the effect of the workpiece.

### Technique 7

The determination device according to Technique 5 or 6, wherein the controller determines whether the clearance is appropriate based on the detection value of the load sensor, the detection value being detected during a period from when the punch having punched the workpiece separates from the workpiece to when the punch arrives at the top dead center.

With such a configuration, it is possible to reduce the effect of the workpiece in the determination of the appropriateness of the clearance between the punch and the stripper.

### Technique 8

The determination device according to any one of Techniques 1 to 7, wherein the load sensor includes a plurality of load sensors.

With such a configuration, it is possible to determine whether the clearance between the punch and the stripper is appropriate, more precisely.

### Technique 9

The determination device according to Technique 8, wherein the plurality of load sensors are disposed at equal intervals on a surface of the punch, on an opposite side of a press surface of the punch.

With such a configuration, it is possible to identify a part where the clearance is not appropriate.

### Technique 10

The determination device according to Technique 8 or 9, wherein the controller identifies a position of a part where the clearance is not appropriate in the side surface of the punch, based on the detection value of each of the plurality of load sensors. With such a configuration, the clearance between the punch and the stripper can be easily adjusted.

### Technique 11

A determination method for determining, for a pressing die including a punch, a stripper having a hollow being where the punch is inserted, and a die, whether a size of a clearance between a side surface of the punch and an inner wall of the hollow of the stripper is appropriate, the determination method comprising: detecting a load exerted on the punch; and determining whether the clearance is appropriate based on a detected load, wherein the determining includes determining that the clearance is not appropriate when the load detected at the detecting exceeds a predetermined threshold value.

With such a configuration, it is possible to provide a determination method capable of determining whether the size of the clearance between the side surface of the punch and the inner wall of the hollow of the stripper is appropriate.

### Technique 12

A press machine comprising:
a punch;
a stripper having a hollow being where the punch is inserted;
a die; and
the determination device according to any one of Techniques 1 to 10.

With such a configuration, it is possible to provide a press machine capable of determining whether the size of the clearance between the side surface of the punch and the inner wall of the hollow of the stripper is appropriate.

According to the present disclosure, it is possible to provide a determination device, a determination method, and a press machine capable of determining whether the size of the clearance between the side surface of the punch and the inner wall of the hollow of the stripper is appropriate.

The determination device, the determination method, and the press machine according to the present disclosure are useful for determining the appropriateness of the clearance between the punch and the stripper in the pressing die when a workpiece used for home electric appliances, medical devices, or the like is to be punched out.

What is claimed is:

1. A determination device that determines, for a pressing die including a punch, a stripper having a hollow being where the punch is inserted, and a die, whether a size of a clearance between a side surface of the punch and an inner wall of the hollow of the stripper is appropriate, the determination device comprising:
a load sensor configured to detect a load exerted on the punch; and
a controller configured to determine whether the clearance is appropriate based on a detection value of the load sensor, wherein
the controller determines that the clearance is not appropriate when the detection value of the load sensor exceeds a predetermined threshold value.

2. The determination device according to claim 1, wherein the controller determines whether the clearance is appropriate based on the detection value of the load sensor, the detection value being detected during the time from when the punch has started moving from a top dead center toward a bottom dead center to when the punch having reached the bottom dead center arrives at the top dead center again.

3. The determination device according to claim 2, wherein the controller determines whether the clearance is appropriate based on the detection value of the load sensor, the detection value being detected when the punch is caused to move, without the pressing die being mounted on the press machine.

4. The determination device according to claim 3, wherein the controller determines whether the clearance is appropriate based on the detection value of the load sensor, the detection value being detected during a predetermined period of the time from when the punch has started moving from the top dead center toward the bottom dead center to when the punch having reached the bottom dead center arrives at the top dead center again.

5. The determination device according to claim 2, wherein the controller determines whether the clearance is appropriate based on the detection value of the load sensor, the detection value being detected when the punch is caused to move, with the pressing die being mounted on the press machine and a workpiece being placed on the die.

6. The determination device according to claim 5, the controller determines whether the clearance is appropriate based on the detection value of the load sensor, the detection value being detected during a time period from when the stripper and the die come into contact with each other with the workpiece interposed therebetween, to when the punch comes into contact with the workpiece.

7. The determination device according to claim 5, wherein the controller determines whether the clearance is appropriate based on the detection value of the load sensor, the detection value being detected during a period from when the punch having punched the workpiece separates from the workpiece to when the punch arrives at the top dead center.

8. The determination device according to claim 1, wherein the load sensor includes a plurality of load sensors.

9. The determination device according to claim 8, wherein the plurality of load sensors are disposed at equal intervals on a surface of the punch, on an opposite side of a press surface of the punch.

10. The determination device according to claim 8, wherein the controller identifies a position of a part where the clearance is not appropriate in the side surface of the punch, based on the detection value of each of the plurality of load sensors.

11. A determination method for determining, for a pressing die including a punch, a stripper having a hollow being where the punch is inserted, and a die, whether a size of a clearance between a side surface of the punch and an inner wall of the hollow of the stripper is appropriate, the determination method comprising:
detecting a load exerted on the punch; and
determining whether the clearance is appropriate based on a detected load, wherein
the determining includes determining that the clearance is not appropriate when the load detected at the detecting exceeds a predetermined threshold value.

12. A press machine comprising:
a punch;
a stripper including a hollow being where the punch is inserted;
a die; and
the determination device according to claim 1.
